(19) United States
(12) Patent Application Publication
(10) Pub. No.: US 2026/0249991 A1
(43) Pub. Date: Aug. 27, 2026

(54) AERIAL VEHICLE

(71) Applicant: FORTESCUE UK IP LIMITED, Edinburgh (GB)

(72) Inventors: Justus BENAD, Delft (NL); Roelof VOS, Delft (NL)

(73) Assignee: FORTESCUE UK IP LIMITED, Edinburgh (GB)

(21) Appl. No.: 19/161,112

(22) PCT Filed: Feb. 29, 2024
(86) PCT No.: PCT/NL2024/050094

§ 371 Date: Aug. 29, 2025

(30) Foreign Application Priority Data
Mar. 1, 2023 (NL) 2034242

(51) Int. Cl. B64C 39/10; B64C 3/10

(52) U.S. Cl. CPC B64C 39/10; B64C 3/10

(57) ABSTRACT

An aerial vehicle comprising a first wing and a second wing, each of the first and the second wing comprising a pressurized compartment for receiving a payload, wherein each of the first and the second wing comprises a first wing portion, a second wing portion, and a transition wing portion connecting the first wing portion and the second wing portion wherein the pressurized compartment is arranged in the first wing portion and in the transition wing portion, wherein a pressurized wing skin defining the pressurized compartment comprises a tip-facing end and an aft-facing end, wherein the aft-facing end, when seen from the trailing edge, follows an end of the pressurized compartment, and wherein the tip-facing end, when seen for the leading edge, is positioned in the transition wing portion and extends in the streamwise direction, until it meets the aft-facing end.

### BACKGROUND

The present invention is related to an aerial vehicle, in particular an aircraft, more in particular a relatively novel type of aircraft known as a “Flying V”. Such an aircraft was proposed for the first time in patent application DE 10 2014 201 040 A1 (filed in the name of Airbus Operations GmbH and mentioning one of the present inventors as inventor) and described there as a aircraft with a first swept wing, which is arranged at a sweep angle with respect to the line perpendicular to the longitudinal axis of the aircraft, and a second swept wing which is arranged symmetrically with respect to the first wing compared to the longitudinal axis of the aircraft. The aircraft has a first payload section, which is integrated in a portion of the first wing and is arranged near the leading edge, and which extends generally parallel to the extension direction of the leading edge sweep angle of the first wing. The aircraft also has a second payload section, which is integrated in a portion of the second wing which is arranged near the leading edge, and which extends generally parallel to the extension direction of the leading edge sweep angle of the second wing. The aircraft may further have a tip section which has a lower sweep angle and is arranged on the first and the second wing in a spanwise direction. In other words, the flying V aircraft disclosed in DE 10 2014 201 040 A1 may be described as having two symmetrical wings, each of the wings having a first wing portion with a large sweep angle and housing the passengers; and a second wing portion with a lower sweep angle.

Work on a flying V aircraft design has also been carried out at the Delft University of Technology by a research group led by Roelof Vos, one of the inventors of the present application. This research has led to several (scientific) publications in between 2017 and 2022, as well as flights with a scaled prototype design from 2020.

Before a drastically new aircraft concept such as a flying-V is built on real scale and can take passengers for commercial flight purposes, many problems need to be overcome regarding the detailed design of said aircraft. The present disclosure relates in particular to the design of the part of the wing where the first wing portion, that may be thick and housing the passengers, morphs into the second wing portion, that may be thin. In particular, this wing portion, defined in the below as the transition wing portion, is subject to many different trade-offs to e.g. keep structural weight as low as possible while on the other hand increasing the lift over drag ratio of the aircraft/minimizing the drag coefficient/increasing the cruise speed.

As such, it is an object of the present disclosure to optimize the wing structural layout of an aerial vehicle of the described type, in particular the wing structural layout in the region where the first wing portion morphs into the second wing portion.

### SUMMARY OF THE DISCLOSURE

As such, the present disclosure relates to an aerial vehicle comprising a first wing and a second wing, each of the first and the second wing comprising a pressurized compartment, defined by a pressurized skin, for receiving a payload,
wherein each of the first and the second wing comprises:
   a first wing portion having a first leading edge sweep angle and a first trailing edge sweep angle,
   a second wing portion having a second leading edge sweep angle and a second trailing edge sweep angle that respectively differ in magnitude from the first leading edge sweep angle and the first trailing edge sweep angle, and
   a transition wing portion connecting the first wing portion and the second wing portion to each other, the transition wing portion defined, when seen in spanwise direction, in between a streamwise-oriented line through a point at the trailing edge of the wing where the first trailing edge sweep angle transitions to the transition trailing edge sweep angle and the streamwise-oriented line through a point at the leading edge of the wing where the transition leading edge sweep angle transitions to the second leading edge sweep angle,
wherein the pressurized compartment is arranged inside of the first wing portion as well as inside of the transition wing portion,
wherein the pressurized wing skin defining the pressurized compartment comprises a tip-facing end and an aft-facing end,
wherein the aft-facing end of the pressurized wing skin, when seen from the trailing edge of the wing, follows an end of the pressurized compartment and is at least partially arranged in the transition wing portion, and
wherein the tip-facing end of the pressurized compartment, when seen from the leading edge of the wing, is positioned in the transition wing portion and extends in the streamwise direction, until it meets the aft-facing end.

Advantageously, due to the pressurized wing skin being arranged not only in the first wing portion but also in the transition wing portion, compared to previous solutions the structure of said transition wing portion may be greatly simplified while a pressurized compartment for payload may be created inside the transition wing portion. The need for a heavy, complex and costly skin in skin solution to create a pressurized compartment in the transition wing portion may thereby at least partially be removed. This thus leads to a lighter structure, reduced manufacturing costs and a larger payload volume.

Advantageously, due to the tip-facing end of the pressurized wing skin extending in the streamwise direction from the leading edge of the wing, at the same time favourable wing profiles may be obtained for all possible cross-sections of the entire transition wing portion. As such, drag may be minimized, especially at high subsonic speeds.

For the purpose of defining the present invention, the aerial vehicle of the present disclosure comprises a first wing and a second wing. For example, the roots of these wing may be mounted to each other, so that an inversely V-shaped aircraft is obtained. However, in alternative embodiments a fuselage of some sorts may be present in between the wings. In further alternative embodiments a third, fourth, etc. wing may be present in between the first wing and the second wing, such a further wing e.g. being arranged at a sweep angle as well. In particular, the first wing and the second wing may be arranged symmetrical with respect to a forward flight direction of the aerial vehicle.

In accordance with the present disclosure, each of the first and the second wing comprises a pressurized compartment. In particular, the pressurized compartment may at least partially be used to seat passengers so that the passengers sit inside the wings. Alternatively and/or simultaneously the pressurized compartment may be used to carry freight, including possibly livestock.

In accordance with the present disclosure, the pressurized compartment is defined by a pressurized skin, which more in particular may be the skin that defines (also) the shape of the wing. As such, when a pressurized wing skin is referred to in the present disclosure, no reference is made to aerodynamic pressure differences between the top and the bottom of the wing surface, which ensure that the wing lifts off/stays in the air, but rather the internal pressurization of the pressurized compartment is meant. That way, inside the pressurized compartment semi-atmospheric conditions may be present, just like in the fuselage of “conventional” planes, compared to the environment at cruise height where pressure and temperature may be unbearable for human beings.

In accordance with the present disclosure, the first and the second wing each have a first wing portion, a second wing portion and a transition wing portion.

When seen in a spanwise direction from the root of the wing towards the tip of the wing, the first wing portion will typically be arranged near the root or contain the root, have a relatively high sweep angle and a thick wing profile. The sweep angle of the first wing portion is high so that the payload is positioned relatively close to the centre axis of the aerial vehicle. This leads to a minimizations of accelerations experienced by the payload during manoeuvres of the aerial vehicle. The wing profile is thick to obtain a large payload volume.

The second wing portion will typically be arranged near the tip of the wing or contain the tip. The sweep angle of the second wing portion may be low compared to the sweep angle of the first wing portion, to increase the wing span and obtain a favourable lift/drag ratio for the aerial vehicle, as well as to obtain favourable handling qualities of the aerial vehicle. The wing profile of the second wing portion may be thin to obtain favourable aerodynamic characteristics. The transition wing portion then needs to connect the thick profile of the first wing portion to the thin profile of the second wing profile, while among other things minimizing structural weight, maximizing aerodynamic performance and maximizing payload volume. In order to connect the thick wing profile of the first wing portion to the thin wing profile of the second wing portion the 3D shape of the transition wing's wing profile will typically be varying across different cross-sections, to gradually blend the shape of the first wing portion into the shape of the second wing portion.

Each of the first wing portion, the second wing portion and the transition wing portion has a sweep angle, which may be zero for at least one of the portions.

Furthermore, it is not required that the wing sweep angle—be it the leading edge sweep angle or the trailing edge sweep angle—is constant throughout the respective wing portion. In particular, the trailing edge sweep angle may vary across a particular wing section.

In accordance with the present disclosure, the pressurized compartment extends beyond the first wing portion and into the transition wing portion.

This pressurized compartment is defined by the wing skin, which is thus a pressurized wing skin. Preferably, said skin is formed as a single-layer wing skin, having a tip-facing end and an aft-facing end. It is not required that the entire wing skin e.g. the first wing portion is pressurized. For example, the pressurization may be present only in between the leading edge of the wing region and an aft spar of the wing region—or an equivalent reinforcing structural member including a bulkhead.

For example, the pressurization may be present only in between the front spar of the wing and the aft spar of the wing region—or any equivalent reinforcing structural members including bulkheads.

The tip-facing end of the pressurized compartment is positioned in the transition wing portion of the wing, at a spanwise position that may be a design variable and depend on the specific requirements and design trade-offs made during the development phase of the aerial vehicle. The tip-facing end extends generally in the streamwise direction of the aerial vehicle when seen from the leading edge of the wing, so generally parallel to the direction of forward flight. However, a variation of a few degrees, e.g. up to 7-10 degrees, is of course allowable. The tip-facing end does not continue all the way towards the trailing edge but is, rather, interrupted by the aft-facing end of the wing skin. This aft-facing end of the wing skin, seen from the trailing edge of the wing, follows an end of the pressurized compartment until it meets the tip-facing end at some point in the transition wing portion of the wing. In embodiments the tip-facing end of the pressurized compartment is defined by a structural member such as a rib or a bulkhead, running in the streamwise direction from the leading edge. However, the end of the pressurized compartment may in alternative embodiments be defined by an imaginary end line, the imaginary end line drawn along the line/region in the transition wing portion where the pressurized compartment transitions towards the height of the second wing portion, even when a more modest height transition may already be present near the end of the first wing portion/inboard of the tip-facing end line. Optionally, the area outboard of the tip-facing end line may still be pressurized. As such, when seen in the spanwise direction, according to the present invention the pressurized compartment present inside the transition wing portion initially substantially retains the same height as the first wing region, to only become significantly lower after the tip-facing end line has been reached.

In an embodiment of the disclosure, the second leading edge sweep angle is smaller than the first leading edge sweep angle. As discussed in the above, this may result in a favourable centre of gravity from a control perspective, while simultaneously achieving a wing span that is sufficiently large to have a favourable lift/drag ratio.

In an embodiment of the disclosure the second trailing edge sweep angle is smaller than the first trailing edge sweep angle. It is however by no means required that the sweep angles of on the one hand the leading edge and on the other hand the trailing edge of a wing portion are similar or the same. For example, a chord of a wing portion may decrease in the spanwise direction as a result of the trailing edge sweep angle being smaller than the leading edge sweep angle.

It may however be preferred when the pressurized section has a relatively constant cross-section, so that passengers seated in the pressurized section experience this as sitting in an “ordinary” plane, having a fuselage. Additional and/or alternative reasons for having a pressurized section with a relatively constant cross-section may be that it simplifies both design and manufacturing work, and thus unit costs. Furthermore, it may be more easy to “scale” the aerial vehicle when the pressurized section has a constant cross-section, so that a true aircraft family, with more of less payload volume between different members of the family, may be obtained while minimizing the number of parts needed for the entire family.

In an embodiment of the disclosure a wing profile of the second wing portion has a smaller thickness/chord (t/c) ratio than a wing profile of the first wing portion. In the first wing portion, the constraint of needing to carry a payload inside the wing may be more of a determining factor for the selection of the wing profile, leading to a relatively thick airfoil for a large payload volume, whereas for the second wing portion the aerodynamic performance of the wing portion may be more of a determining factor for the selection of the wing profile, leading to a relatively thin airfoil for a large lift/drag ratio. It should be noted however that, in embodiments, due to a relatively high sweep angle of the first wing section with the relatively large t/c ratio, the wing profile as defined in the chordwise direction, from leading edge to trailing edge, may substantially differ from the wing profile in the streamwise direction parallel to the direction of forward flight so that nonetheless reasonable aerodynamic performance is obtained for the first wing portion.

In an embodiment of the disclosure the roots of the first wing and the second wing are connected to one another, the aerial vehicle being a flying-V type aircraft. Preferably, in such a case the first wing and the second wing are fully symmetrical to each other.

In an embodiment of the disclosure the leading edge sweep angle of the transition region substantially equals the leading edge sweep angle of the first wing portion. However, it is very well possible that the leading edge sweep angle of the transition region differs from the leading edge sweep angle of the first wing portion. If the two sweep angles differ, it is most likely that the leading edge sweep angle of the transition region has a magnitude in between the leading edge sweep angle of the first portion and the leading edge sweep angle of the second portion. As stated in the above, although it may be convenient, it is not required that the leading edge sweep angle of the first wing portion is constant. The first wing portion may have two or more sub-portions that each may have their own leading edge sweep angle. The same holds for the transition wing portion and the second wing portion.

In an embodiment of the disclosure the trailing edge sweep angle of the transition region substantially equals the trailing edge sweep angle of the second wing portion. However, it is very well possible that the trailing edge sweep angle of the transition region differs from the trailing edge sweep angle of the second wing portion. If the two sweep angles differ, it is most likely that the trailing edge sweep angle of the transition region has a magnitude in between the trailing edge sweep angle of the first portion and the trailing edge sweep angle of the second portion. As stated in the above, although it may be convenient, it is not required that the trailing edge sweep angle of the transition wing portion is constant. The transition wing portion may have two or more sub-portions that may each have their own trailing edge sweep angle. The same holds for the first wing portion and the second wing portion.

In an embodiment of the disclosure the transition wing portion, at a spanwise position beyond the tip-facing end of the pressurized wing skin, comprises an extended pressurized compartment. For example, this further pressurized compartment may be formed by reinforcing and pressurizing the wing skin of that part of the transition wing portion. In such an embodiment the tip-facing end of the main pressurized compartment may be imaginary. As described in the above, the pressurized compartment is distinguished in that it has a relatively constant height until the tip-facing end thereof. As such, the height in the extended pressurized compartment will be lower and typically reduce at a relatively high slope angle.

In an alternative embodiment, a physical end structure may be present at the end of the main pressurized compartment, separating the main pressurized compartment from the extended pressurized compartment.

Further alternatively the further pressurized compartment may be formed by a sub-structure in the interior of the wing skin, leaving the wing skin itself unpressurized.

In an embodiment of the disclosure the first wing portion comprises the wing root. As such, the first wing portion may alternatively be referred to as the “inboard” wing portion.

In an embodiment of the disclosure the second wing portion comprises the wing tip. As such, the second wing portion may alternatively be referred to as the “outboard” wing portion.

In an embodiment of the disclosure, when seen in a spanwise direction, a wing profile of the transition wing portion outboard of the tip-facing end of the pressurized skin is different compared to a wing profile of the transition wing portion inboard of the tip-facing end of the pressurized skin. As described: at the cross-section where the pressurized compartment is present, a relatively thick profile is ideally used to allow a sufficient payload volume to be present inside the pressurized compartment. However, beyond the pressurized compartment the (cross-sectional) shape of the transition wing portion should change towards the airfoil shape of the second wing section, which may be thinner. This change is preferably gradually, e.g. linearly, so that each streamwise airfoil section in between the tip-facing end of the pressurized wing skin and the start of the second wing portion may be different/unique.

It is noted that the wing profiles of the transition wing portion inboard of the tip-facing end may be much more similar to each other, especially for the chordwise length until the aft-facing end. Beyond the location of the aft-facing end, also such airfoil profiles may be different for different spanwise cross-sections of the transition wing section.

In an embodiment of the disclosure an angle between the tip-facing end of the pressurized wing skin and the aft-facing end of the pressurized wing skin is blunt.

However, this is not a requirement per se. Depending in particular on the precise shape of the pressurized compartment inside the wing and the chosen location of the streamwise oriented tip-facing end of the pressurized wing skin a perpendicular or an acute angle may result between the ends. At the connection point of the two end lines a rounded pressure bulkhead may be implemented to more gradually transfer forces from the one end to the other end.

In an embodiment of the disclosure the aft-facing end of the pressurized wing skin starts along the trailing edge of the first wing portion. It might be preferred when the cross-section of the pressurized compartment is relatively constant. This would mean that the pressurized compartment ends near the area where the transition wing portion starts, as from there the wing might become significantly slimmer. Keeping in mind required structural reinforcements near the end of the pressurized compartment as well as where the wing sweep angle changes, an end of the pressurized compartment, seen along the trailing edge of the wing, may be positioned just before the end of the first wing portion. However, in line with what is described in the above, more towards the leading edge the pressurized compartment will extend into the wing transition portion, to maximize the pressurized volume and thereby the payload volume.

These and other aspects of the present disclosure will be elucidated further with reference to the attached figures. In these figures:

### BRIEF DESCRIPTION OF THE FIGURES

FIG. 1 schematically shows, in a top view, an embodiment of an aerial vehicle according to the present disclosure; and

FIG. 2 schematically shows, in a top view, a detail of the aerial vehicle shown in FIG. 1; and

FIG. 3 schematically shows a front view of a part of the aerial vehicle shown in FIG. 1.

### DETAILED DESCRIPTION OF THE FIGURES

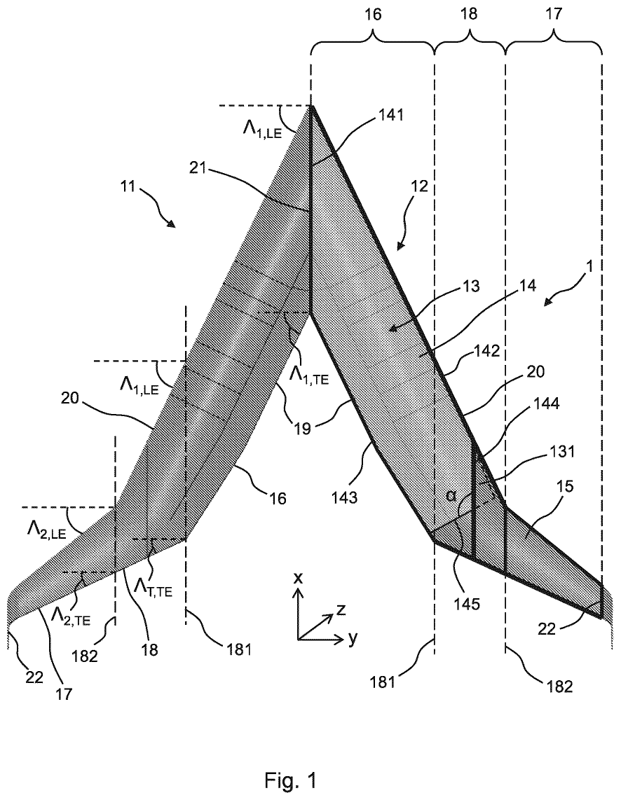

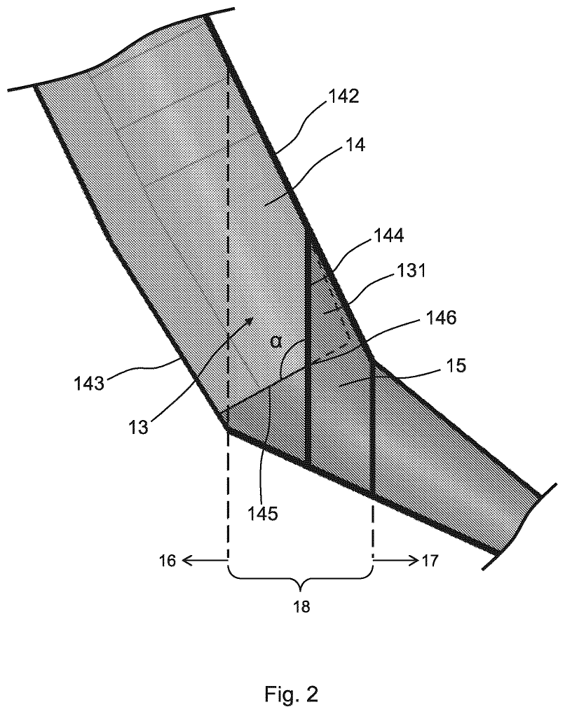

FIGS. 1 and 2, which will be discussed together, schematically show a non-limiting embodiment of the present disclosure. With reference mainly to FIG. 1 initially, an aerial vehicle 1 is shown for carrying a payload, such as passengers. The aerial vehicle lacks a traditional fuselage but instead carries the payload in its wings 11, 12. As such, a part of the wing skin may be pressurized, such wing skin indicated by reference numeral 14, whereas another part of the wing skin may be unpressurized, such wing skin indicated by reference numeral 15. The wings 11, 12 are connected to each other at their respective roots. This new type of aircraft configuration has become to be known as the “flying V” configuration. There are two wings 11, 12, one on the left-hand side of the figure along the negative y axis, and one on the right-hand side of the figure along the positive y axis. The wings 11, 12 are arranged symmetrically to each other and are joined to each other at their respective wing roots 21. As one skilled in the art will know, the wings 11, 12 each have a thickness and are hollow on the inside, allowing a pressurized compartment 13 to be formed inside the wings 11, 12; the pressurized compartment 13 designed to receive the payload such as the passengers. As any conventional wing, a root 21, a tip 22, a leading edge 20 and a trailing edge 19 may be defined for the wings 11, 12.

For each wing 11, 12 three different portions may be defined. From inboard to outboard these are the first wing portion 16, the transition wing portion 18 and the second wing portion 17.

The first wing portion 16, comprising the root 21 of the wing here has a first leading edge sweep angle Λ_{1,LE}, that may or may not be constant along the entire first wing portion 16. The first wing portion 16 also has a first trailing edge sweep angle Λ_{1,TE}, that may or may not be constant along the entire first wing portion 16. The first wing portion 16 will typically have a relatively high thickness over chord ratio, to create a large useable inner volume.

The second wing portion 17, comprising the tip 22 of the wing here has a second leading edge sweep angle Λ_{2,LE}, that may or may not be constant along the entire second wing portion 17. The second wing portion 17 also has a second trailing edge sweep angle Λ_{2,TE}, that may or may not be constant along the entire second wing portion 17. The thickness over chord ratio may be significantly smaller in the second wing portion 17, to increase the aerodynamic performance.

As may be seen from the figure, the first leading edge sweep angle Λ_{1,LE} is larger than the second leading edge sweep angle Λ_{2,LE}, and the first trailing edge sweep angle Λ_{1,TE} is larger than the second trailing edge sweep angle Λ_{2,TE}. This results in a first wing portion 16 that extends mostly to the back and a second wing portion 17 that extends mostly to the side. Such a configuration is found to create the optimum in terms of controllability due to the centre of gravity being in a favourable position, as well as an optimum in terms of lift and lift over drag ratio due to the wing span being increased.

In between the first wing portion 16 and the second wing portion 17 is the transition wing portion 18. The transition wing portion 18 starts at line 181, where the trailing edge sweep angle transitions from the first trailing edge sweep angle to the transition trailing edge sweep angle. When seen in the streamwise direction, the direction parallel to the y-axis/forward flight, the direction in which line 181 is drawn, it is evident that it is only at a relatively much more outboard position, indicated by line 182, where also the leading edge sweep angle transitions from the transition leading edge sweep angle to the second leading edge sweep angle. It is in between these two lines 181 and 182 that the transition wing portion of the wing is defined. In the shown embodiment the leading edge sweep angle of the transition region Λ_{T,LE} substantially equals the leading edge sweep angle of the first wing portion Λ_{1,LE}, but this is not required per se. Also, in the shown embodiment the trailing edge sweep angle of the transition region Λ_{T,TE} substantially equals the trailing edge sweep angle of the second wing portion Λ_{2,TE} but this is not required per se.

Practical and theoretical experiments carried out over the last few year with previous designs of a flying-V aerial vehicle have learned among many other things that it is the design of this transition wing portion 18 which is of critical importance to the performance of the entire aerial vehicle 1. On the one hand, one wants to use as much of the internal volume of this transition wing portion 18 as payload volume, preferably as a pressurized compartment. On the other hand, the aerodynamic characteristics of this wing portion 18 are crucial for the drag and lift generated by the aerial vehicle 1. As the transition wing portion 18, quite literally, has to bridge the gap between the thick first wing portion 16 and the thin second wing portion 17, the cross-section shape of the transition wing portion 18 cannot be the same at all places.

It is now found by the inventors that a gradual change in this shape, gradually changing over the entire portion, may not be the optimal solution. Instead an approach is proposed where, seen from a structural construction perspective, the pressurized wing skin 14 extends beyond the first wing portion 16 and into the transition wing portion 18, wherein in the transition wing portion 18 the pressurized compartment 13 retains substantially the same height as in the first wing portion 16. When looking at the end of the pressurized wing skin 14 from the trailing edge 143 thereof, initially an aft-facing end line 145 of the pressurized skin 14 follows the end of the pressurized compartment 13. When looking at the end of the pressurized wing compartment 13 from the leading edge 142, initially a tip-facing end 144 thereof extends in the streamwise direction. At a certain point, here indicated by reference numeral 146, the aft-facing end line 145 and the tip-facing end 144 meet and essentially cut each other off. The exact spanwise location of the tip-facing end 144, and hence the exact spanwise location where the aft-facing end line 145 is cut off, may be a design variable influenced amongst others by structural weight, payload volume and aerodynamic performance and may vary among different aircraft designs. However, the inclusion of a pressurized wing skin 14 extending into the transition wing portion 18 of the wing 11, 12, and being defined by a tip-facing end 144 as described in the above and an aft-facing end line 145 as described in the above, to allow this optimization for these different design variables at the same time is deemed to be a crucial addition to the prior art.

As a result of the wing skin 14 being pressurized and defining a pressurized payload compartment 13 until the place where the tip-facing end 144 is positioned, the airfoil shape of the transition wing portion 18 may be relatively thick—especially just as thick as in the first wing portion—at least until the aft-facing end line 145 of the pressurized wing skin 14 is reached. As a result thereof, in combination with the significantly different airfoil sections that may be selected for the first wing portion 16 and the second wing portion 17, all airfoil sections of the transition wing portion 18 outboard of the tip-facing end 144 may be unique.

As is mainly visibly in FIG. 2, an extended pressurized compartment 131 may be arranged inside the wing 12. For example, the extended pressurized compartment 131 may be formed by a separate structure inside the unpressurized wing skin 15, i.e the wing skin 15 itself may be unpressurized and arranged above a substructure 131 which is pressurized, so that a skin-in-skin structure results. Alternatively, the wing skin may be reinforced and pressurized to form the further pressurized compartment 131. In such a case the further pressurized structure 131 may be distinguished from the pressurized surface 14 by a rib or bulkhead running below the tip-facing end 144 of the pressurized surface 13, the rib physically separating the pressurized surface 14 from the further pressurized compartment 131. However, the tip-facing end 144 may just as likely be defined by an imaginary surface 144 that distinguishes the main part 13 of the pressurized compartment, where the internal height is substantially constant, from a more outboard extension portion 131 of the pressurized compartment, where the internal height decreases rapidly.

As is particularly visible in FIG. 2, an angle α may be defined between the aft-facing end 145 of the pressurized wing skin 14 and the streamwise-oriented tip-facing end 144 of the pressurized wing skin 14. As the tip-facing end 144 of the skin 14 is oriented in the streamwise direction, plus or minus a few degrees, the magnitude of the angle α mainly depends on the direction in which the aft-facing end 145 of the pressurized surface 14 is running from the trailing edge 19 of the wing 12 to the leading edge 20 of the wing 12. Typically, said angle α will be larger than 90°.

Also best visible in FIG. 2 is that the aft-facing end 145 of the pressurized skin 14, when seen from the trailing edge 19 of the wing 12, may be arranged substantially perpendicular to said trailing edge 19.

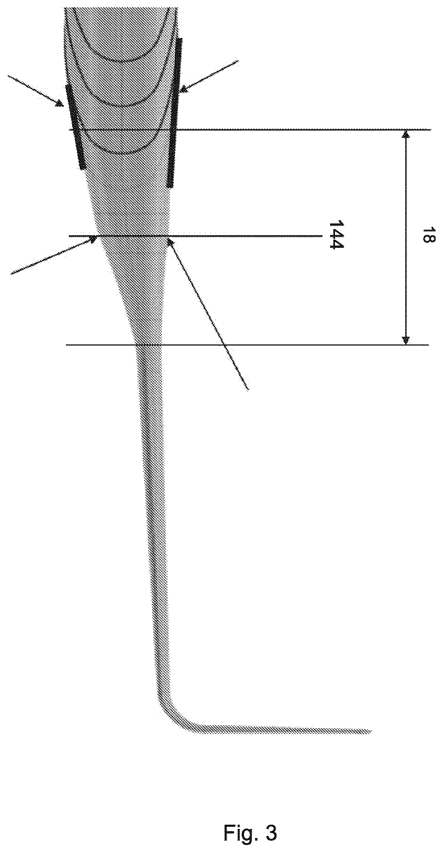

Turning now to FIG. 3, the tip-facing end line 144 is indicated in a front view of the aerial vehicle, where the local height of the wing skin, and thus of the pressurized compartment, may be better seen than in the top views of FIGS. 1 and 2. Indicated in FIG. 3 is where the transition wing portion 18 starts (when seen in the spanwise direction from the root), and where the transition wing portion ends (when seen in the spanwise direction from the root). Inboard of the transition wing portion 18 is the first wing portion; outboard of the transition wing portion 18 is the second wing portion. As shown by the thick lines following the top and bottom wing surface, at the point where the transition wing portion 18 starts a height of the wing—and thus, of the pressurized compartment—may already start to decrease slightly. It is only at the point where the decrease in height becomes more significant, e.g. due to a step in the slope, that the end 144 of the pressurized compartment is defined.

1. An aerial vehicle (1) comprising a first wing (11) and a second wing (12), each of the first (11) and the second wing (12) comprising a pressurized compartment (13), defined by a pressurized wing skin (14), for receiving a payload, wherein each of the first (11) and the second wing (12) comprises:
a first wing portion (16) having a first leading edge sweep angle (Λ_{1,TE}) and a first trailing edge sweep angle (Λ_{1,TE}),
a second wing portion (17) having a second leading edge sweep angle (Λ_{2,TE}) and a second trailing edge sweep angle (Λ_{2,TE}) that respectively differ in magnitude from the first leading edge sweep angle (Λ_{1,LE}) and the first trailing edge sweep angle (Λ_{1,TE}), and
a transition wing portion (18) connecting the first wing portion (16) and the second wing portion (17) to each other, the transition wing portion (17) defined, when seen in a spanwise direction (y), in between a streamwise-oriented line (181) through a point at the trailing edge (19) of the wing (11, 12) where the first trailing edge sweep angle (Λ_{1,TE}) transitions to a transition trailing edge sweep angle (Λ_{T,TE}) and the streamwise-oriented line (182) through a point at the leading edge (20) of the wing (11, 12) where the transition leading edge sweep angle (Λ_{T,LE}) transitions to the second leading edge sweep angle (Λ_{2,LE}), wherein the pressurized compartment (13) is arranged inside of the first wing portion (16) as well as inside of the transition wing portion (18), wherein the pressurized wing skin (14) defining the pressurized compartment (13) comprises a tip-facing end (144) and an aft-facing end (145), wherein the aft-facing end (145) of the pressurized wing skin (14), when seen from the trailing edge (19) of the wing (11, 12), follows an end of the pressurized compartment (13) and is at least partially arranged in the transition wing portion (18), and wherein the tip-facing end (144) of the pressurized compartment (13), when seen from the leading edge (20) of the wing (11, 12), is positioned in the transition wing portion (18) and extends in the streamwise direction, until it meets the aft-facing end (145).

2. The aerial vehicle according to claim 1, wherein the second leading edge sweep angle (Λ_{2,LE}) is smaller than the first leading edge sweep angle (Λ_{1,LE}) and/or wherein the second trailing edge sweep angle (Λ_{2,TE}) is smaller than the first trailing edge sweep angle (Λ_{1,TE}).

3. The aerial vehicle according to claim 1, wherein a wing profile of the second wing portion (17) has a smaller thickness/chord (t/c) ratio than a wing profile of the first wing portion (16).

4. The aerial vehicle according to claim 1, wherein the roots (141) of the first wing (11) and the second wing (12) are connected to each other, the aerial vehicle (1) being a Flying-V aircraft.

5. The aerial vehicle according to claim 1, wherein the transition leading edge sweep angle (Λ_{T,LE}) substantially equals the first leading edge sweep angle (Λ_{1,LE}).

6. The aerial vehicle according to claim 1, wherein the transition trailing edge sweep angle (Λ_{T,TE}) substantially equals the second trailing edge sweep angle (Λ_{2,TE}).

7. The aerial vehicle according to claim 1, wherein the transition wing portion (18), at a spanwise position beyond the tip-facing end (144) of the pressurized component (13), comprises an extended pressurized compartment (131).

8. The aerial vehicle according to claim 1, wherein the first wing portion (16) comprises the wing root (21).

9. The aerial vehicle according to claim 1, wherein the second wing portion (17) comprises the wing tip (22).

10. The aerial vehicle according to claim 1, wherein, when seen in the spanwise direction (y), a wing profile of the transition wing portion (18) beyond the tip-facing end (144) of the pressurized compartment (13) is different compared to a wing profile of the transition wing portion (18) before the tip-facing end (144) of the pressurized compartment (13).

11. The aerial vehicle according to claim 1, wherein an angle (a) between the tip-facing end (144) of the pressurized wing compartment (13) and the aft-facing end (145) of the pressurized wing skin (14) is blunt.
